(19) United States
(12) Patent Application Publication
(10) Pub. No.: US 2008/0251243 A1
(43) Pub. Date: Oct. 16, 2008

(54) HEAT-EXCHANGE ELEMENT AND METHOD OF MAKING SAME

(75) Inventors: Marc Frank DIMTER, Kornwestheim (DE); Ralph Mayer, Kornwestheim (DE)

Correspondence Address: K.F. ROSS P.C., 5683 RIVERDALE AVENUE, SUITE 203 BOX 900, BRONX, NY, 10471-0900, US

(73) Assignee: LBC LaserBearbeitungsCenter GmbH

(21) Appl. No.: 12/102,167

(22) Filed: Apr. 14, 2008

(30) Foreign Application Priority Data
Apr. 13, 2007 (DE) 102007017914.8-16

(51) Int. Cl. F28F 3/14; B23P 15/26; F28F 1/00

(52) U.S. Cl. 165/170; 29/890.039; 165/177

(57) ABSTRACT

A heat-exchange element has a substrate plate having a face and a channel formed by fused deposited powder fixed to the face and forming with the face a laterally closed passage. The channel is made by applying powder to the face of the substrate plate and fusing successive layers of the powder to the face to form the channel fixed on and open toward the face.

### FIELD OF THE INVENTION

The present invention relates to a heat-exchange element. More particularly this invention concerns a heat-exchange element having a passage through which a heat-exchange medium flows and a method of making the element, in particular an element of the type used to heat an extruder.

### BACKGROUND OF THE INVENTION

U.S. Pat. No. 7,139,633 teaches a process for making a tool in which an alloy of, for instance, molybdenum, is powder-deposited in a layered manner on a substrate of much softer material, e.g. aluminum. This process is used to make complexly shaped dies, which can even be formed with cooling passages. The process entails covering the entire surface of the substrate with powder and initially fusing a layer of the powder to the substrate. Subsequently further layers of powder are applied to the substrate and are fused locally to build up selected locations. Such a system is very slow and is typically only used for custom manufacturing of individual parts or prototypes.

US patent publication 2002/0165634 describes another powder-deposition process where powder is deposited and fused on a laminated base substrate using direct metal deposition (DMD). The fused powder layer thus formed can be selected in such a manner that it has a desired surface characteristic. Cooling conduits can also be integrated into the applied layer by leaving regions unfused and subsequently emptying out the unfused powder. Again this method is very slow and expensive.

These systems have the disadvantage that the layer produced by such powder deposition is relatively difficult to manufacture. In addition they are primarily intended to create an article whose powder-deposited parts act as tools.

German published patent 10 2005 050 118 describes a method of machining cooling passages in a workpiece using laser-guided material removal. Such an arrangement allows complex passages to be formed, but does not go beyond simple material removal. The material in which the passages are formed has to be compatible with the coolant flowed through them, so that it is not applicable to workpieces that could be eroded by the coolant.

Going further, German published patent 199 37 315 describes a complex computer-aided-design (CAD) system that is used to make a heat-exchange element. Here the entire element is laid down, layer-by-layer, by a powder deposition process. This system is fairly complex and very slow, so that the resultant element is very expensive.

### OBJECTS OF THE INVENTION

It is therefore an object of the present invention to provide an improved heat-exchange element.

Another object is the provision of such an improved 5 heat-exchange element that overcomes the above-given disadvantages, in particular that can have virtually any shape yet that can be produced inexpensively.

A further object is to provide an improved method of making a heat-exchange element having a lined flow passage.

Yet another object is to provide such a heat-exchange element where the passage is lined with a high-quality chemical-resistant material but where otherwise the element is formed by materials that are easier to work, more common, and less expensive.

### SUMMARY OF THE INVENTION

A heat-exchange element has according to the invention a substrate plate having a face and a channel formed by fused deposited powder fixed to the face and forming with the face a laterally closed passage. The channel is made by applying layers of powder to the face of the substrate plate and fusing successive strips of the layers of the powder to form the channel fixed on and open toward the face. Here the term “channel” means an elongated element of generally U- or V-section that is open in one lateral direction.

With the heat-exchange element according to the invention the heat-exchange channel is formed by the layered application of a metallic powder on the substrate plate and a fusing of the layer in only limited areas, typically along strips or lines forming the sides of the channel and at the end as a wide strip closing the channel. The inner surface of the structure produced in this manner forms the heat-exchange passage. The wall thickness and the shape of the tubular structure can differ along the length of the heat-exchange channel. The substrate plate can be designed planar or of three-dimensional shape, so that it face is planar, a warped plane, or a more complex three-dimensional surface.

This substrate plate can be a relatively common material while the powder used to make the cooling passages is of a material specifically selected to be compatible, e.g. nonreactive, with the coolant to be used. The substrate plate can be made in a traditional manner and it is therefore not made from powder. The heat-exchange channel produced in this manner can be received in a groove of a cover plate of the element. The groove can be made by milling. However, other methods of manufacture are also conceivable. The cover plate may have several grooves. Moreover, the cover plate can also comprise at least one other heat-exchange channel.

The substrate plate in the sense of the invention can be any component of the heat-exchange element, e.g., a tool part such as a tool plate, a tool insert, or a mold. The surface of the substrate plate can be planar or freely formed. Therefore, the side wall of the heat-exchange channel formed by powder is fused at its edge directly to the substrate plate.

According to the invention “tubular” means laterally closed on all sides and only open at one or both ends. The part of the heat-exchange channel formed by fused powder has, in contrast to a large-area layer, a limited wall thickness. Thus the channel can be formed and laid down relatively quickly, with the laser/electron-beam welder scanning back and forth and only fusing the layer along the strips that will make up the coolant passage.

Two heat-exchange channels for the forward and return flow of a heat-exchange channel can have a common wall and be separated from one another by a partition. One side of the heat-exchange channel can be formed directly by the face of the substrate plate.

The powder used according to the invention can be any fusible metallic material. In order to fuse the powder, it is possible to use a laser-welding apparatus or an electron-beam or plasma welder.

The invention has the advantage that the heat-exchange element for heating or cooling can be made with a much lower manufacturing cost, especially in a shorter working time. The material and shape of the heat-exchange channel over its length can be freely selected. They can therefore be adapted to the structural conditions of the heat-exchange element.

According to a first embodiment the heat-exchange passage is delimited in part by a face of the substrate plate and otherwise by the inner surface of the channel. This is advantageous when the heat-exchange medium dies not react with the material of the substrate plate.

According to another embodiment the entire inner surface of the passage is defined by the fused powder. To this end a strip of the powder is fused to a face of the substrate plate and then the edges of this strip are built up to form the side walls of the passage, and eventually a top strip is fused together to bridge the outer edges of the side walls. This is done by applying successive layers of the powder to the substrate, but only fusing the powder where needed. When the tubular structure, formed by the channel, is complete, the loose powder inside it is blown or sucked out to complete the structure. The powder can be high-grade steel. This embodiment can be used to prevent the heat-exchange medium from reacting with the material of the substrate plate, which can be made of a more easily worked and less expensive material such as mild steel. Corrosion of the substrate plate as well as contamination of the heat-exchange medium can be prevented by coating the face of the substrate plate so that it does not interact with the heat-exchange medium.

According to another embodiment the substrate plate and the cover plate are connected to one another in a positive and/or a non-positive manner. For example, the substrate plate and the cover plate can be connected to one another by screws. A sealing agent can be provided between the substrate plate and the cover plate. This prevents heat-exchange fluid from leaking out of the heat-exchange element if it escapes from the heat-exchange channel. The heat-exchange channel made from powder is as a rule gas-tight, but if a leak should nevertheless occur, the sealing agent provided between substrate plate and cover plate can prevent potentially catastrophic loss of the heat-exchange medium.

According to another embodiment the substrate plate and the cover plate are formed of tool steel. A commercial tool steel has the advantage that it is commercially available, is inexpensive, and can be obtained in different sizes, e.g. as a standard specification. The heat-exchange channel fused on the substrate plate can be formed by high-grade, e.g. stainless, steel, which prevents corrosion of the heat-exchange channel by the heat-exchange medium.

In order to prevent the wall of the heat-exchange channel from being corroded by the heat-exchange medium it can be constructed on all sides by a high-grade steel. To this end a layer of high-grade steel powder is fused to the face of the substrate plate, to form the floor of the tubular heat-exchange passage otherwise formed by the channel on the substrate plate. Alternatively, the wall of the heat-exchange channel can be formed on one side by the substrate plate itself, e.g. if the material of the substrate plate is not corroded by the heat-exchange medium.

According to a further embodiment of the invention the heat-exchange channel has a substantially elliptical shape. This shape can be readily made and enables good heat transfer because of the large surface. However, other shapes can be alternatively selected for the cross section of the heat-exchange channel.

According to another embodiment a heat-conducting mass is arranged between an outside surface of the heat-exchange channel and an inside surface of the groove in the cover plate. This material can be a heat-conducting paste. The use of the heat-conducting material makes better heat transfer between the heat-exchange medium in the passage and the cover plate.

An air gap between the heat-exchange channel and the cover plate would have insulating properties and only modest heat transfer would take place between the cover plate and the heat-exchange channel. In order to avoid such a the gap the groove of the cover plate would have to be exactly complementary to the heat-exchange channel. The use of a heat-conducting medium, for instance a conductive paste, in the space between the heat-exchange channel and the inside wall of the groove creates a heat-conducting bridge. For this reason in this embodiment the shape of the heat-exchange channel can differ from the shape of the groove. For example, the cross-sectional shape of the heat-exchange channel can be elliptical and the cross-sectional shape of the groove semicircular.

According to another embodiment the heat-exchange channel is provided with a connection fitting that makes possible connection to a supply and discharge for a heat-exchange medium, either liquid or gaseous. Such connections can be threaded or have a snap closure. The connection fitting can be designed in such a manner that connection of the heat-exchange medium supply or heat-exchange medium discharge is possible from an outer or opposite face of the heat-exchange element. To this end the connection fitting can for example have a connection to a channel in an adjacent part of the heat-exchange element.

According to another embodiment of the invention an intermediate part is provided between the cover plate and the substrate plate and in turn is provided with at least one heat-exchange channel and/or at least one groove. The part of the heat-exchange element can comprise at least one heat-exchange channel and at least one groove for receiving a heat-exchange channel. The part of the apparatus can be formed by a plate of a heat-exchange element and comprise at least one groove on the one plate side as well as at least one heat-exchange channel on the other place side that can be received in a groove of another part of the heat-exchange element. Grooves and heat-exchange channels can also be provided on the same plate side and correspond with appropriately designed grooves and heat-exchange channels of another tool plate. The heat-exchange element can comprise several parts, e.g. several plates each with one or several heat-exchange channels and/or grooves for heat-exchange channels.

### BRIEF DESCRIPTION OF THE DRAWING

The above and other objects, features, and advantages will become more readily apparent from the following description, reference being made to the accompanying drawing in which:

FIG. 1 is a cross-sectional view through a heat-exchange element according to the invention;

FIG. 2 is, like FIG. 1, a sectional view of part of the heat-exchange element in accordance with the invention;

FIG. 3 is a view like FIG. 2 of an alternative construction according to the invention;

FIG. 4 is a perspective view of a plate with two heat-exchange channels and connection fittings to the heat-exchange medium supply and heat-exchange medium discharge;

FIG. 5 is a cross section through the cover plate of FIG. 1;

FIG. 6 is a cross section through a two-passage heat-exchange element according to the invention;

FIG. 7 is a small-scale top view of a heat-exchange plate with two separate channels;

FIG. 8 is a section taken along line VIII-VIII of FIG. 7;

FIG. 9 is a section taken along line IX-IX of FIG. 8;

FIG. 10 is a section taken along line X-X of FIG. 7;

FIG. 11 is a section taken along line XI-XI of FIG. 10;

FIG. 12 is a small-scale top view of another heat-exchange element in accordance with the invention;

FIG. 13 is a section taken along line XIII-XIII of FIG. 12;

FIG. 14 is an end view illustrating the method of this invention.

### SPECIFIC DESCRIPTION

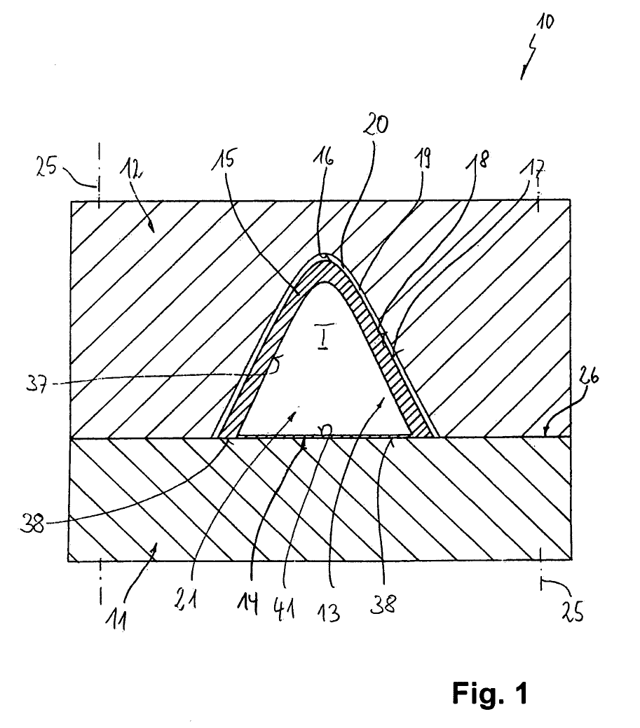

As seen in FIG. 1 a heat-exchange element 10 is basically formed by a cover plate 12 and a substrate or base plate 11 having a planar upper face 31. A generally U-section heat-exchange channel 13 has a side wall 15 and forms with a floor 14 a heat-exchange passage 21. The floor 14 and wall 15 are made of high-grade steel whereas the plates 11 and 12 are of tool steel.

The heat-exchange channel 13 is received in a groove 16 of the cover plate 12. A gap or space 20 is formed between an outside surface 17 of the side wall 15 of the heat-exchange channel 13 and an inside surface 18 of the groove 16. A heat-conducting paste 19 is received in this space 20 and substantially fills it. The heat-conducting medium 19 serves to create a heat bridge in the space 20 in order to create a better heat transfer between the cover plate 12 and the wall 15 and to get good heat exchange with a heat-exchange medium T flowing in the passage 21 formed inside the heat-exchange channel 13. If no heat-conducting medium 19 is provided in the intermediate space 20, e.g. in certain areas, the air present in the intermediate space 20 has an insulating effect, so that poor heat transfer is the consequence. This can be desired in certain areas of the heat-exchange element 10 in order to obtain a lesser heat exchange between the heat-exchange medium and the heat-exchange element at these locations.

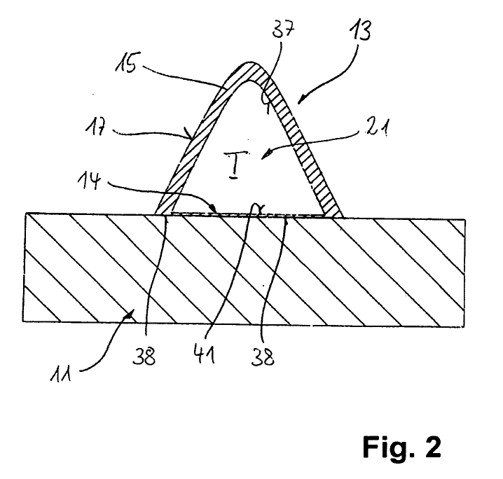

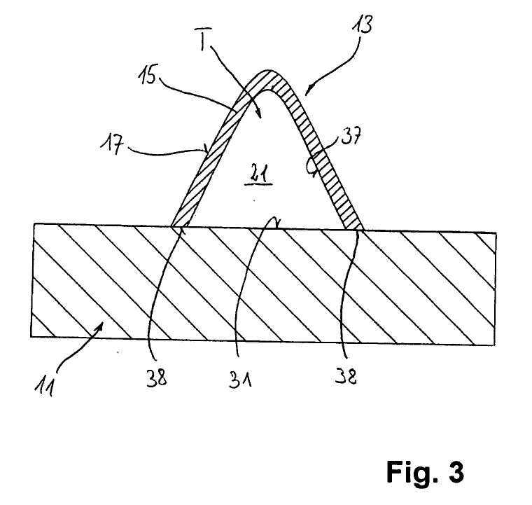

The base plate 11 shown in FIG. 2 is a separate part made from a tool steel while the floor 14 and side wall 15 of the heat-exchange channel 13 are formed from a corrosion-resistant high-grade steel. The passage 21 is thus delimited by an inside surface 37 of the wall 15 of the channel 13 and by an outside surface 41 of the floor 14. This embodiment prevents the plates 11 and 12 from being directly contacted and corroded by the heat-exchange medium T and also prevents contamination of the heat-exchange medium T and impairment of the functionality of heat-exchange channel 13 from leakage. Since the floor 14 is also made from high-grade steel, a reaction between the heat-exchange medium T and the base plate 11 cannot take place. In case the heat-exchange medium T does not react chemically with the material of the base plate 11, the floor 14 of heat-exchange channel 13 can be eliminated as shown in FIG. 3. Thus, the heat-exchange channel 13 is delimited in this embodiment by the inside surface 37 of the wall 15 and by the outside surface 31 of the base plate 11.

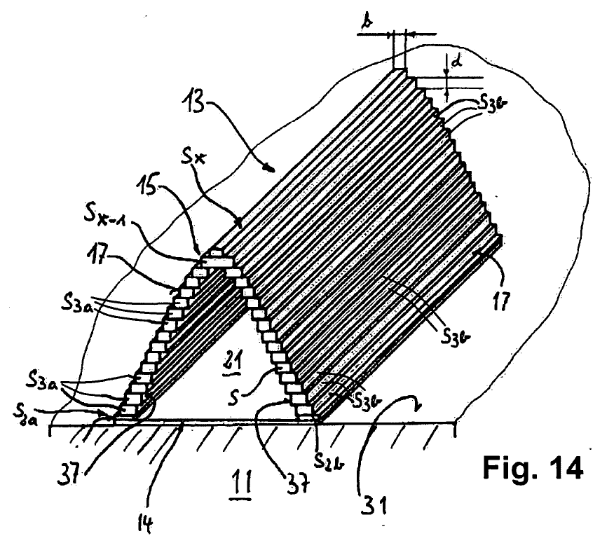

As shown in FIG. 14, the floor 14 and the wall 15 of the heat-exchange channel 13 are made by powder-deposition techniques. At first, a layer of powder is applied to the face 31 of the base plate 11 over the entire area where the heat-exchange conduit or passage is to be formed. The layer thickness d depends on the material, and the strip width b also is determined by the wall thickness needed. In the present instance the layer thickness d is approximately 0.02 mm. The powder layer is fused directly on the surface 31 as two layers S2ₐ and S2_{b} extending generally parallel by a laser beam guided according to the shape that the heat-exchange channel is to have in the particular layer plane. Subsequently further strips S3ₐ and S3_{b} are stacked atop them, by applying layers of powder successively fusing strips of them. The strips S3ₐ and S3_{b} are set at an increasingly closer transverse spacings until finally a final wide strip Sₓ₋₁ is formed that bridges the two top strips S3ₐ and S3_{b}, with a final narrow strip Sₓ on top of that, forming the downwardly V- or U-shaped form that is needed. Alternatively, the powder layer could also be fused by other welders, e.g., by an electron beam.

The laser beam can be strongly focused during irradiation of the areas of each individual powdery layer that are provided where an edge surface 38 meets the base plate 11 and on the outside surface 16 and the inside surface 37 of the wall 15 in the finished heat-exchange channel 13. Areas of each layer that are further removed from the outside surfaces and that form core regions of the wall 15 of the heat-exchange channel 13 can be irradiated with a less strongly focused laser beam. This has the consequence that the metallic powder is less strongly melted in the core. Relative movement in the structure of the heat-exchange channel 13 as the result of thermal expansion and contraction are thus possible and tensions can therefore be better reduced and cracks avoided in this manner.

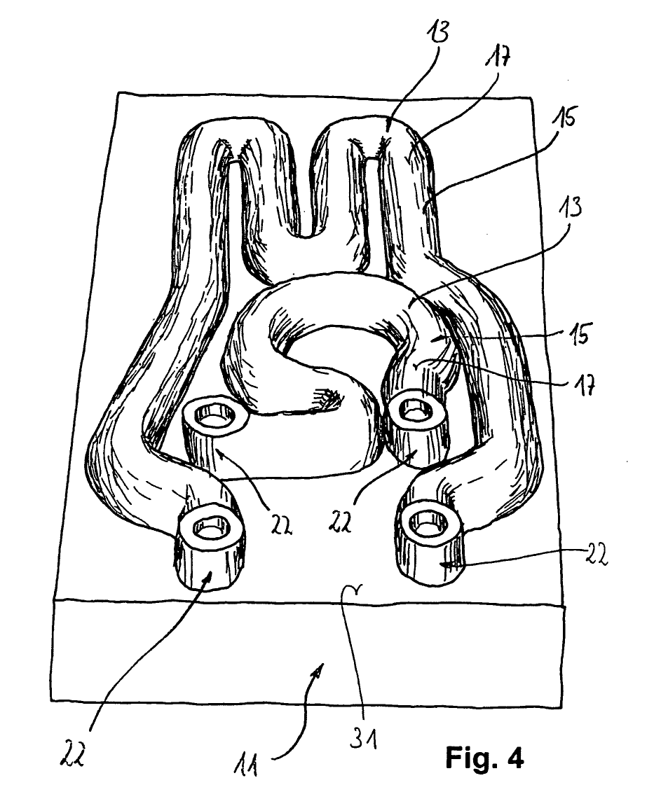

Following fusing of strips of the first layer another layer of powder is applied and fused in strips on top of the already fused strips with the laser. These process steps are repeated again and again until the heat-exchange channel 13 or several heat-exchange channels 13 are completely formed on the base plate 11 and/or an intermediate plate 39 mentioned below (see FIG. 4). The final fused strips bridge the outer edges of the two strips forming the side walls. In this manner the floor 14 of the heat-exchange channel 13 and the wall 15 are built up in a layered manner on the base plate 11. The powder that is still loose at the sites that were not fused with the laser can subsequently be removed, e.g., by shaking it out or by blowing it out.

The heat-exchange channel 13 shown in the drawings has a wall 15 with an elliptically shaped cross section. However, other cross-sectional shapes of the heat-exchange channel 13 are also conceivable.

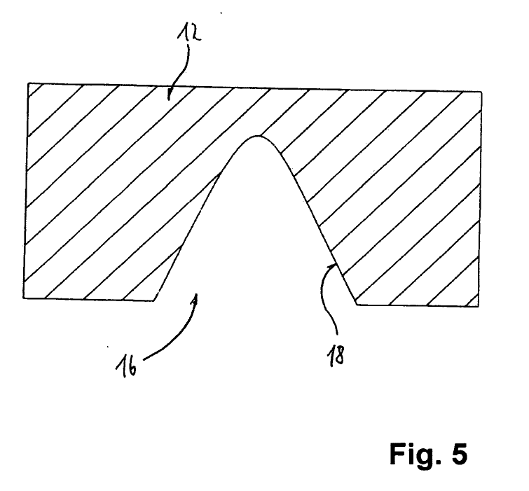

The groove 16 in the cover plate 12 can be designed to be exactly complimentary to the outside shape of the heat-exchange channel 13 so as to fit snugly therewith or can be only generally shaped to conform to the outside shape. According to FIG. 1 and 5 the groove 16 is also designed in an elliptical manner complimentary to the cross-sectional shape of wall 15 of the substrate plate 11 and made, for example, by milling. However, the groove 16 can also have a shape differing from the cross-sectional shape of the wall 15, for example, a partially circular shape that can be produced by a ball milling head.

The shape of the heat-exchange channel 13 does not have to be constant over the entire length of heat-exchange channel 13. The cross-sectional shape of heat-exchange channel 13 can vary as a function of the structural conditions and/or requirements in the heat-exchange element 10.

The heat-exchange channel 13 can have connection fittings 22 on its end (see FIG. 4) to which a heat-exchange means supply and a heat-exchange means discharge can be connected. The connection fitting 22 can be cylindrical or can be connected via a connection tube (not shown) to a coupling apparatus (not shown) on the outer side of heat-exchange element 10. A supply for a heat-exchange liquid or gas can be readily connected to the coupling. A groove (not shown) for the connection fitting 22 can be provided in the cover plate 12 by means of which the connection fitting 22 is connected, e.g. via a passage, to an outside face of the heat-exchange element 10 so that a simple connection to the outside of the heat-exchange element 10 is possible.

The base plate 11 and the cover plate 12 can be positively and/or non-positively connected to one another. In the illustrated embodiment according to FIG. 1 the base plate 11 and the cover plate 12 are clamped against one another by a screw connection shown schematically at 25. A sealing agent 26 is provided between the base plate 11 and the cover plate 12. In this manner an additional safety against loss of the heat-exchange medium T from a leak forms.

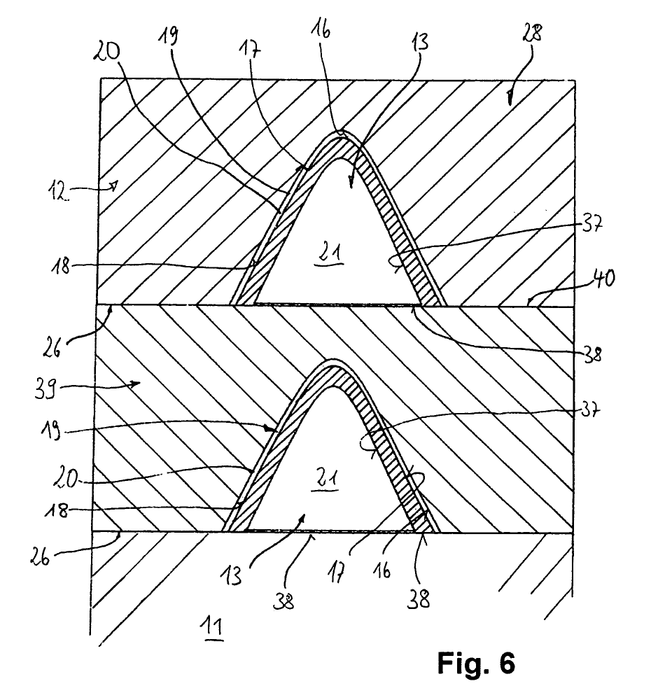

In the illustrated embodiment according to FIG. 6 an intermediate plate 39 is provided between the base plate 11 and the cover plate 12. The intermediate plate 39 has a groove 16 in which the heat-exchange channel 13 of the base plate 11 is received. Also, a heat-exchange channel 13 is provided on an opposite side 40 of the intermediate plate 39 facing away from the base plate 11, which heat-exchange channel is made in the same manner as heat-exchange channel 13 of the base plate 11. The heat-exchange channel 13 of the intermediate plate 39 is provided in a groove 16 of the cover plate 12. In practice a stack of plates 11 and 12 can be made, and in fact two channels 13 can be formed on opposite sides of a single substrate plate 11 or conversely two substrate plates 11 can flank a cover plate formed with two grooves 14, and so on. Any desired number of intermediate plates 39 can be provided between base plate 11 and the cover plate 12 and can have one or more grooves 16. In addition, the intermediate plates 39 can comprise one or more heat-exchange channels 13. In this manner cooling channels 13 can be placed at any site within the structure.

Several heat-exchange circuits can be provided at different locations on the structure as shown in FIG. 4. The various heat-exchange channels 13 can be provided on a plate or on different plates of the heat-exchange element 10.

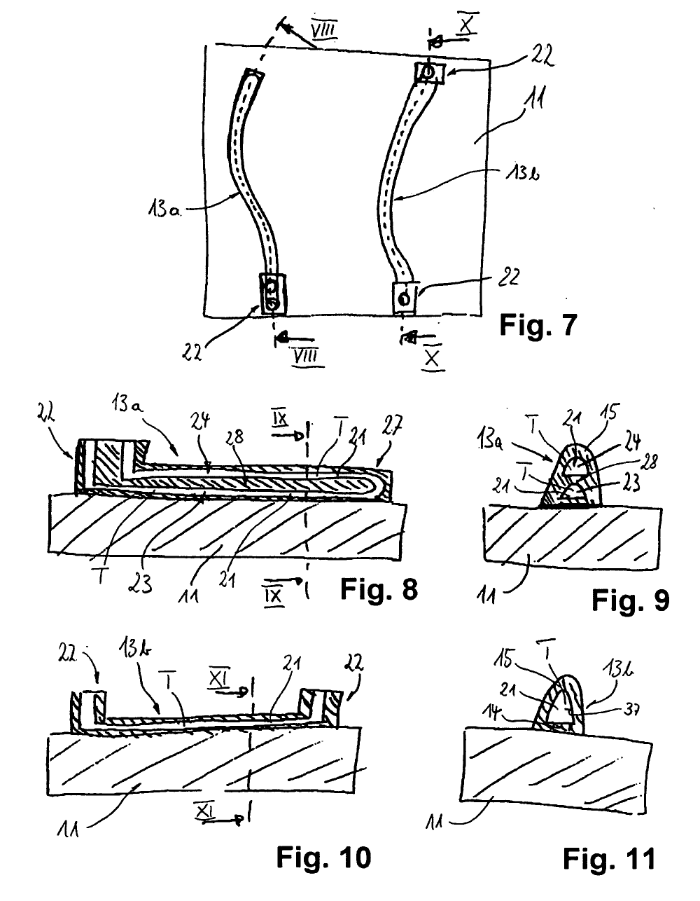

For example, several heat-exchange channels 13 can be constructed above one another or adjacent to one another and have a common wall 15. According to FIG. 7 to 9 a forward flow 23 and a return flow 24 of a heat-exchange channel 13a are provided in a superposed manner and connected to one another at an end area 27. A separating web or partition 28 is designed between the forward flow 23 and the return flow 24. At the connection fitting 22 the forward flow 23 can be connected to a supply line (not shown) and the return flow 24 can be connected to an intake of the heat-exchange means T (also not shown). In the heat-exchange channel 13b the supply and discharge of heat-exchange means take place via separate connection fittings 22.

The heat-exchange channels 13 can also be connected to channels located on or in other parts, e.g. in other tool plates. These can be heat-exchange channels that are made in the same manner by powder-application fusing. Alternatively, they can also be bores or grooves formed in parts of the heat-exchange element 10.

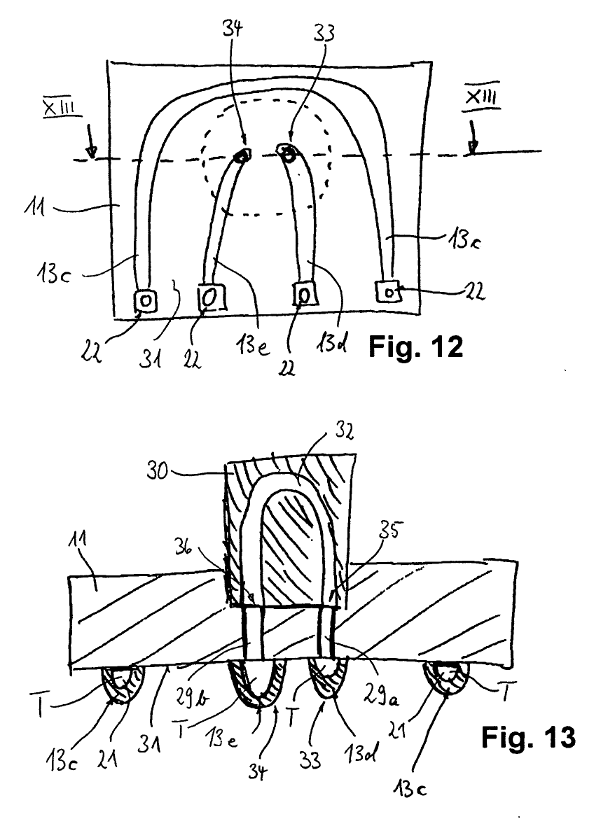

According to FIG. 12 and 13 heat-exchange channels 13c, 13d and 13e are provided on the surface 31 of the base plate 11. The heat-exchange channel 13d is connected in an area 33 by a bore 29a and the heat-exchange channel 13e on an end area 34 by a bore 29b. The bore 29a empties into an end area 35 and the bore 29b into an end area 36 of a channel 32 provided in an insert 30. The channel 32 is U-shaped. The forward flow of heat-exchange medium T takes place via the heat-exchange channel 13d and the bore 29a into the channel 32. The return flow can then take place from the channel 32 via the bore 29b and the heat-exchange channel 13e.

It should also be mentioned that as an alternative to the embodiments shown, the heat-exchange channel 13 can also be provided on nonplanar or three-dimensionally shaped surfaces of parts of the heat-exchange element instead of on a planar tool plate. In the present illustrated embodiment the heat-exchange channel 13 in accordance with the invention was used for the heat-exchange of a heat-exchange element 10. However, the heat-exchange channel 13 can also be alternatively used for heat-exchange with any heat-exchange element.

We claim:

1. A method of making a heat-exchange element, the method comprising the step of:
applying successive layers of fusible powder to a portion of a face of a substrate plate; and
fusing strips of the powder to the face and to each other to form a channel fixed on and open toward the face and forming with the plate a laterally closed passage.

2. The method defined in claim 1 wherein the powder is not fused to the face offset from the channel.

3. The method defined in claim 2, further comprising the steps of:
fitting over the channel a cover plate formed with a groove at least generally complementary to the channel with the channel engaging into the groove; and
securing the two plates together.

4. The method defined in claim 3, further comprising the step of
filling a space between an outer surface of the channel and an inner surface of the groove with a heat-conducting substance.

5. A heat-exchange element comprising:
a substrate plate having a face; and
a channel formed by strips of fused deposited powder fixed to the face and forming with the face a laterally closed passage.

6. The heat-exchange element defined in claim 5 wherein a portion of the face of the substrate plate between side walls of channel is directly exposed in the passage.

7. The heat-exchange element defined in claim 5 wherein the channel is tubular and closed and a portion of the channel adheres directly to the face of the substrate plate.

8. The heat-exchange element defined in claim 7 wherein the face is substantially planar and the channel has a generally U-shaped wall open toward the face and a planar floor adhered to the face and closing an open side of the U-shaped wall.

9. The heat-exchange element defined in claim 5, further comprising
a cover plate formed with a groove at least generally complementary to the channel and fitted over the channel with the channel engaging into the groove; and
means for securing the two plates together.

10. The heat-exchange element defined in claim 9 wherein the groove snugly receives the channel.

11. The heat-exchange element defined in claim 9 wherein the groove is a loose fit in the channel.

12. The heat-exchange element defined in claim 9, further comprising
a heat-conducting mass filling a space between an inner surface of the groove and an outer surface of the channel.

13. The heat-exchange element defined in claim 9 wherein both plates are of steel.

14. The heat-exchange element defined in claim 9, further comprising
a seal between the plates.

15. The heat-exchange element defined in claim 9 wherein the cover plate has an opposite face turned away from the substrate plate and the element further comprises:
another channel formed by fused deposited powder fixed to the opposite face and forming with the opposite face another laterally closed passage;
another cover plate formed with another groove at least generally complementary to the other channel and fitted over the other channel with the other channel engaging into the other groove; and
means for securing all the plates together.

16. The heat-exchange element defined in claim 5 wherein the powder is a high-grade steel.

17. The heat-exchange element defined in claim 5 wherein the channel is formed with at least one connection fitting.
